(19) United States
(12) Patent Application Publication
(10) Pub. No.: US 2015/0199243 A1
(43) Pub. Date: Jul. 16, 2015

(54) DATA BACKUP METHOD OF DISTRIBUTED FILE SYSTEM

(71) Applicant: RESEARCH INSTITUTE OF TSINGHUA UNIVERSITY IN SHENZHEN, Shenzhen (CN)

(72) Inventors: Yongwei WU, Shenzhen (CN); Kang CHEN, Shenzhen (CN); Weimin ZHENG, Shenzhen (CN); Zhenqiang LI, Shenzhen (CN)

(21) Appl. No.: 14/593,358

(22) Filed: Jan. 9, 2015

(30) Foreign Application Priority Data
Jan. 11, 2014 (CN) 201410013486.2

(51) Int. Cl. G06F 11/14; G06F 17/30

(52) U.S. Cl. CPC G06F 11/1458; G06F 17/30174; G06F 17/30371; G06F 17/30215; G06F 2201/82

(57) ABSTRACT

A data backup method of a distributed file system is provided. The method is based on a comparison of a source file system and a target file system. Metadata of the target file system is compared with metadata of the source file system. The method includes: synchronizing target metadata of a target file according to source metadata of a source file, generating a file checksum list; determining whether a first target block is consistent with a first source block, obtaining and sending a first updated file checksum list to a first data node; determining whether a first chunk is consistent with a first target chunk, generating a first difference list, sending the first difference list and the first updated file checksum list to a first corresponding target data node; creating a temporary block, writing data in the temporary block, replacing the first corresponding target block with the temporary block.

### CROSS-REFERENCE TO RELATED APPLICATION

This application claims priority to and benefits of Chinese Patent Application Serial No. CN201410013486.2, filed with the State Intellectual Property Office of P. R. China on Jan. 11, 2014, the entire contents of which are incorporated herein by reference.

### FIELD

The present disclosure relates to a distributed file system, and more particularly relates to a data backup method applied in different distributed file systems.

### BACKGROUND

HDFS (Hadoop Distributed File System), an open source distributed file system developed with Java programming language, is an application having high fault tolerance and suitable for a huge dataset. In order to avoid losing data due to a breakdown of equipments, a power outage or a nature disaster (such as an earthquake or a tsunamis), the data in a file system (a source file system) needs to be backup to another file system (a target file system) in a cluster which is far from the source file system and reliable. A data backup instruction “distcp” (Distribute Copy) is provided for backing up data between different systems in various clusters. The data backup instruction “distcp” is a “MapReduce” job and a copy job is executed by Map jobs running parallel in the clusters.

The data backup instruction is configured for copying a file by allocating a single Map to the file, which is based on a file level. A target file in the target file system is deleted and a source file is written in the target file system when a data backup process is executed, even if there is a part of blocks of the source file in the target file, such that it takes a long time to backup data and the network bandwidth is occupied seriously, leading to a high network load. In addition, if an abnormal interruption is occurred when the data backup process is executed or the source file system is migrated, there are a lot of target files which are backed up before the interruption is occurred in the objet file system and the target files are deleted and rewritten if the data backup process is restarted.

### SUMMARY

A data backup method of a distributed file system is provided in the present disclosure. With the data backup method, target files in a target file system may be used efficiently by analyzing source files in a source file system and the target files and creating a strategy of data transmission before a data backup process is executed, thus reducing the amount of data being transmitted between data nodes in different clusters and saving time on the data backup process.

The data backup method of a distributed file system comprises: obtaining by a synchronization control node a copy list according to a source path in a data backup request input from a client, synchronizing target metadata of a target file in the target file system according to source metadata of a source file in the copy list, and generating a file checksum list corresponding to the source file; comparing by the synchronization control node a checksum of a first source block in the source file with a checksum of a first target block in the target file, determining whether the first source block is consistent with the first target block to obtain a first determining result, and updating information of the first source block and a first source data node corresponding to the first source block in the file checksum list according to the first determining result to obtain a first updated file checksum list, and sending the first updated file checksum list to a first data node, wherein the first data node is the first source data node or a first target data node corresponding to the first target block, and the first data node corresponds to a first block which is the first source block or the first target block; receiving by the first data node the first updated file checksum list, comparing a checksum of a first chunk in the first block with a checksum of a first target chunk in a first corresponding target block, determining whether the first chunk is consistent with the first target chunk to obtain a second determining result, generating a first difference list according to the second determining result, and sending the first difference list and the first updated file checksum list to a first corresponding target data node corresponding to the first corresponding target block; and creating a temporary block by the first corresponding target data node, and writing data in the temporary block according to the first difference list and replacing the first corresponding target block with the temporary block.

Compared to a related art, with the data backup method of a distributed file system provided in the present disclosure, target files in a target file system may be made a full use and the amount of data transmitted between data nodes in different clusters is reduced by determining whether data in a source block is sent by a source data node in a source file system or by a target data node in a target file system in a data backup process, and time on the data backup process is saved by backing up data based on a block as a unit.

### BRIEF DESCRIPTION OF THE DRAWINGS

FIG. 1 is a schematic diagram illustrating an operation environment of the data backup method of a distributed file system according to a preferred embodiment of the present disclosure.

FIG. 2 is a flow chart of the data backup method of a distributed file system according to a preferred embodiment of the present disclosure.

FIG. 3 is a flow chart of step S01 illustrated in FIG. 2.

FIG. 4 is a flow chart of step S02 illustrated in FIG. 2.

FIG. 5 is a flow chart of step S03 illustrated in FIG. 2.

FIG. 6 is a flow chart of step S04 illustrated in FIG. 2.

FIG. 7 is a schematic diagram of a file checksum list created in step S01.

FIG. 8 is a schematic diagram of a file checksum list after step S02 is executed.

FIG. 9 is a schematic diagram of a source file backup list.

FIG. 10 is a schematic diagram of a directed acyclic graph created according to records in the file checksum list illustrated in FIG. 8 and in which data nodes are target data nodes.

FIG. 11 is a schematic diagram illustrating a directed acyclic graph after a part of records are handled according to the directed acyclic graph illustrated in FIG. 10.

FIG. 12 is a schematic diagram of a hash table of a plurality of target blocks.

FIG. 13 is a schematic diagram of a target block checksum list.

FIG. 14 is a schematic diagram of a hash table of a plurality of target chunks.

FIG. 15 is a schematic diagram of a difference list.

The data backup method of a distributed file system provided in the present disclosure will be described in detail with the following embodiments with reference to the above drawings.

### DETAILED DESCRIPTION

Related terms in HDFS are described before the data backup method of a distributed file system provided in the present disclosure is described with reference to the embodiments. A HDFS is a system with master-slave architecture, comprising a name node and a plurality of data nodes. A user may store data as files in a HDFS, and each file comprises a plurality of ordered blocks or data blocks (with a size of 64M) storing in the plurality of data nodes. The name node is served as a master server to provide services about metadata and to support a client to realize an accessing operation on files. The plurality of data nodes are configured for storing data. In addition, a concept of “chunk” is introduced in the data backup method of a distributed file system provided in the present disclosure to speed up file transfer in a data backup process. The chunk is a basic unit of a block divided into a plurality of (such as 256) parts in a same size each part of which is called a file slice. The chunk is a smallest storage cell of a logical block.

The data backup method of a distributed file system (hereinafter, called as “data backup method”) provided in the present disclosure may be applied in two HDFSs in different clusters to back up data. With the data backup method, a data backup instruction similar to “distcp” is provided. Parameters of the data backup instruction comprise a source path of a source file system and a target path of a target file system. The data backup instruction is configured to copy files inside the source path to the target path.

For convenience of explanation, in a preferred embodiment, a file in the source file system is called as a source file and a file in the target file system is called as a target file; a data node in the source file system is called as a source data node and a data node in the target file system is called as a target data node; a block in a source file is called as a source block and a block in a target file is called as a target block; a chunk in a source block is called as a source chunk and a chunk in a target block is called as a target chunk. A target block to which a source block is backed up is called as a corresponding target block.

It should be noted that, in a preferred embodiment, a data node as a data sender may be a source data node or a target data node. In other words, the data sender is not limited to a source data node caused by the fact that a content of a source block is not sent by a source data node corresponding to the source block to a corresponding target data node, but is sent by a target data node corresponding to a target block consistent with the source block.

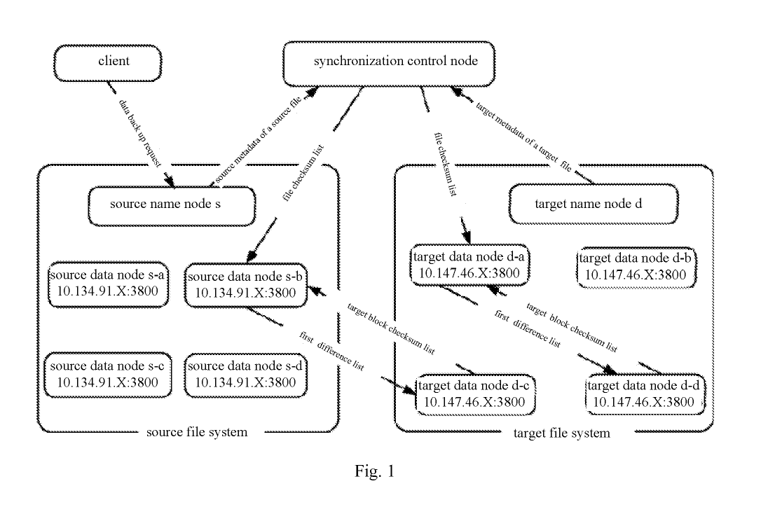

FIG. 1 is a schematic diagram illustrating an operation environment of the data backup method according to a preferred embodiment of the present disclosure.

As shown in FIG. 1, a client provides a user interface for a user to perform various operations (such as a create operation, a move operation, a delete operation or a backup operation) on files or directories in a source file system. The source file system and a target file system are located in two different clusters. The source file system comprises a source name node s and a plurality of source data nodes s-a, s-b, s-c and s-d. The target file system comprises a target name node d and a plurality of target data nodes d-a, d-b, d-c and d-d. In an actual application, a number of the source data nodes and a number of the target data nodes vary with different clusters. A synchronization control node is configured for coordinating a communication between source name node s and target name node d and for controlling the synchronization of source metadata in the source file system and target metadata in the target file system and for sending a data transmission strategy to a source data node and a target data node to transmit data blocks between the source data node and the target data node, so as to realize the data backup. In a preferred embodiment, in order to distinguish from the name nodes and data nodes in the source file system and the target file system, the synchronization control node is an individual node. In other embodiments, the synchronization control node may be the source name node or a source data node in the source file system or may be the target name node or a target data node in the target file system. A communication process and a data transmission process between the nodes (such as data nodes or name nodes) in FIG. 1 may be described in detail with reference to following flow charts.

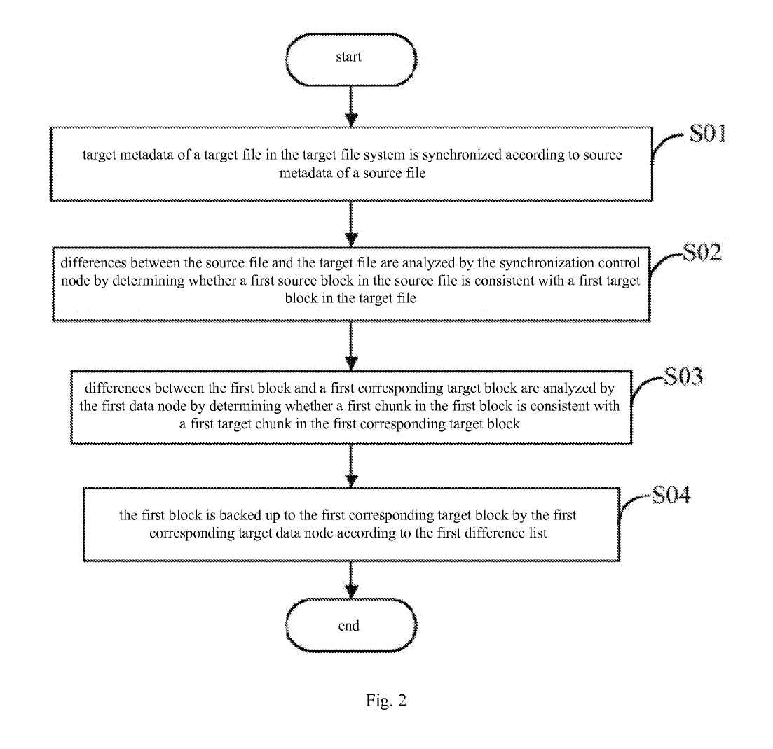

FIG. 2 is a flow chart of the data backup method according to a preferred embodiment of the present disclosure.

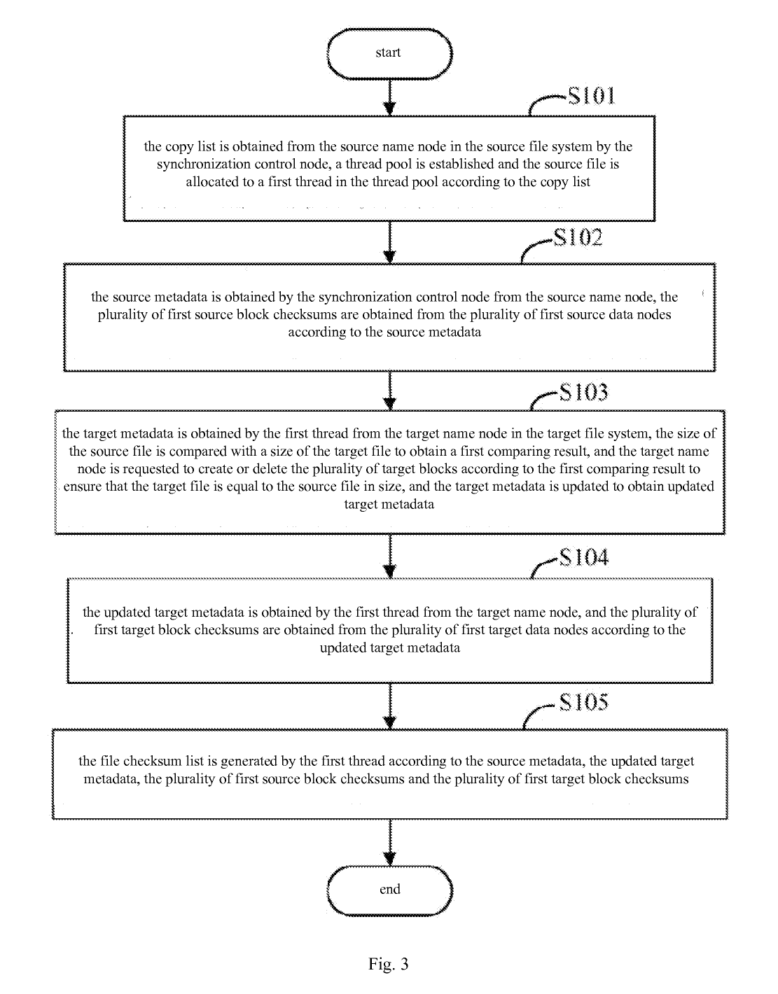

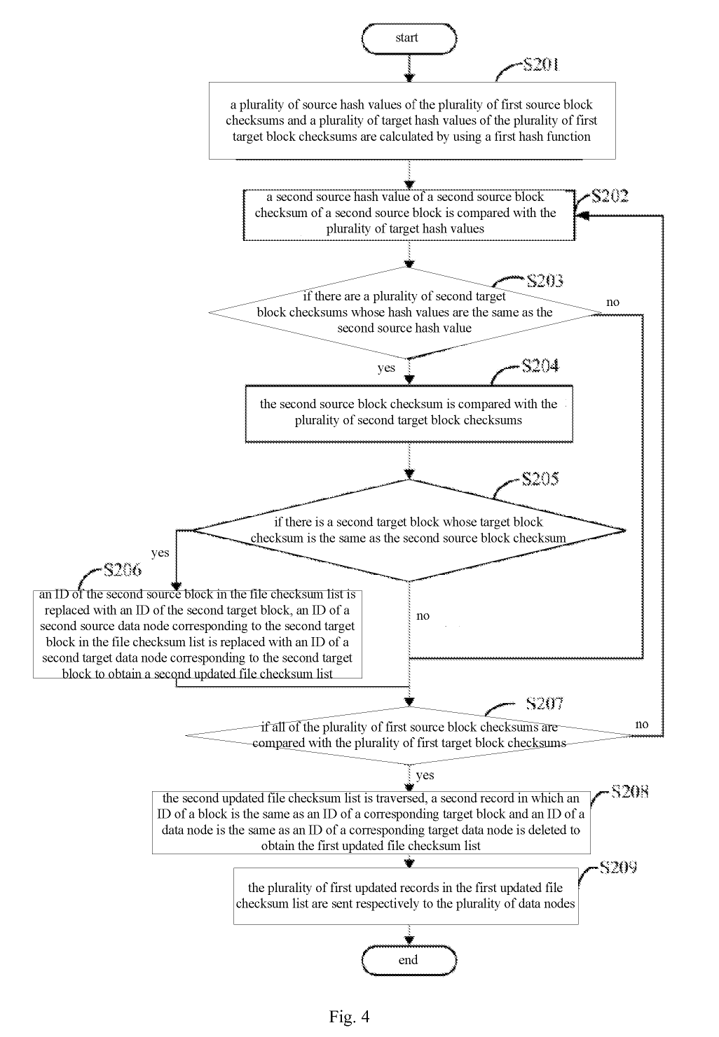

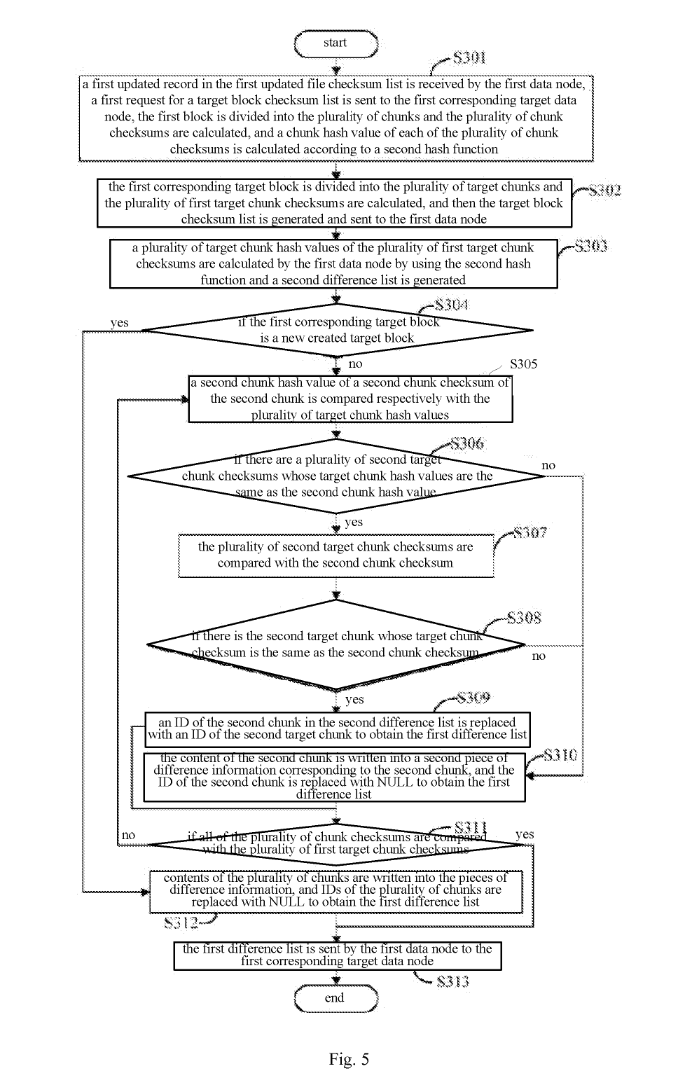

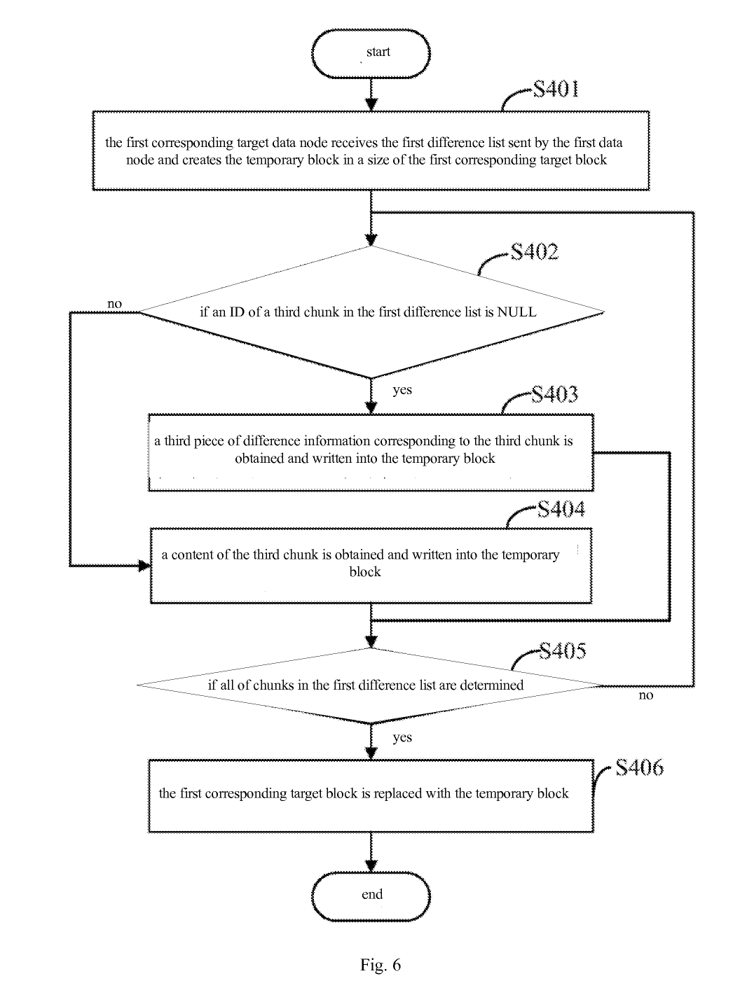

As shown in FIG. 2, a data backup process in the source file system and the target file system realized by the data backup method comprises following steps. Step S01: a copy list is obtained by the synchronization control node according to a source path in a data backup instruction input from the client, and target metadata of a target file in the target file system is synchronized according to source metadata of a source file in the copy list and a file checksum list is generated. A detailed description of step S01 may refer to FIG. 3. Step S02: differences between the source file and the target file are analyzed by the synchronization control node by determining whether a first source block in the source file is consistent with a first target block in the target file. Specifically, a checksum of the first source block is compared with a checksum of the first target block by the synchronization control node to determine whether the first source block is consistent with the first target block to obtain a first determining result, and information of the first source block and a first source data node corresponding to the first source block in the file checksum list is updated according to the first determining result to obtain a first updated file checksum list, and then the first updated file checksum list is sent to a first data node, in which the data node may be the first source data node or a first target data node corresponding to the first target block and the first data node corresponds to a first block which is the first source block or the first target block. A detailed description of step S02 may refer to FIG. 4. Step S03: differences between the first block and a first corresponding target block are analyzed by the first data node by determining whether a first chunk in the first block is consistent with a first target chunk in the first corresponding target block. Specifically, the first updated file checksum list is received by the first data node, and a checksum of the first chunk is compared with a checksum of the first target chunk to determine whether the first chunk is consistent with the first target chunk to obtain a second determining result, and a first difference list is generated according to the second determining result, and then the first difference list and the first updated file checksum list are sent to a first corresponding target data node corresponding to the first corresponding target block. A detailed description of step S03 may refer to FIG. 5. Step S04: the first block is backed up to the first corresponding target block by the first corresponding target data node according to the first difference list. Specifically, a temporary block is created by the first corresponding target data node, data is written into the temporary block according to the first difference list, and then the first corresponding target block is replaced with the temporary block to realize a data backup of the first block. A detailed description of step S04 may refer to FIG. 6. In a word, with the data backup method according to embodiments of the present disclosure, a data backup of source files may be run parallel in the data backup process, a data backup of source blocks in a source file may be run parallel based on a block as a unit in a process of backing up the source file. Therefore, compared to an existing data backup method, a problem that a long time is took on the data backup of a source file is solved and the amount of data transmitted between data nodes in different clusters is reduced in the data backup process by comparing the source file and a target file corresponding to the source file, thus reducing the occupied network bandwidth.

Detailed descriptions of steps in FIG. 2 will be explained with reference to FIGS. 3 to 6.

Step S01, target metadata of a target file in the target file system is synchronized by a synchronization control node according to source metadata of a source file. Specifically, a copy list is obtained by the synchronization control node according to a source path in a data backup request input from a client, and the target metadata of the target file in the target file system is synchronized according to the source metadata of the source file in the copy list and a file checksum list corresponding to the source file is generated.

The copy list is a list of a plurality of source files inside the source path obtained by the synchronization control node from a source name node in the source file system according to the source path in the data backup request. The source file comprises a plurality of first source blocks having a plurality of first source block checksums respectively and corresponding to a plurality of first source data nodes respectively; and the target file comprises a plurality of target blocks having a plurality of first target block checksums respectively and corresponding to a plurality of first target data nodes respectively. Metadata (such as the source metadata or the target metadata) of a file/directory comprises attribute information of the file/directory (such as a filename, a directory name and a size of the file), information about storing the file (such as information about blocks in the file and the number of copies of the file) and information about data nodes (such as a mapping of the blocks and the data nodes) in a HDFS. A synchronization of the source metadata and the target metadata may be realized by determining whether there is the target file in the target file system corresponding to the source file in the copy list and whether the target file corresponding to the source file is equal to the source file in size, requesting a target name node in the target file system to create the target file in the size of the source file if there is no target file corresponding to the source file or to create or delete the plurality of target blocks in the target file if the target file is not equal the source file in size. It should be noted that, in a preferred embodiment, the source file system and the target file system use a same version of HDFS file system, a size of a source block is 64 Mb, and a size of a target block is 64 Mb. After synchronizing the target metadata according to the source metadata, there is the target file equal to the source file in size, a number of the plurality of target blocks is the same as a number of the plurality of first source blocks, and a size of each target block is the same as a size of each source block. The file checksum list comprises a plurality of records; the plurality of records comprise Nos. of the plurality of first source blocks, IDs of the plurality of first source blocks, the plurality of first source block checksums, IDs of the plurality of first source data nodes, IDs of the plurality of target blocks as a plurality of corresponding target blocks, the plurality of first target block checksums, IDs of the plurality of first target data nodes as a plurality of corresponding target data nodes and a plurality of mark bits each of which indicates whether each of the plurality of target blocks is a new created target block. A block checksum (such as a source block checksum or a target block checksum) of a block is a 32-bit hexadecimal numeric string configured to verify the integrality of the block and stored in an individual hidden file in a namespace of the HDFS where the block is stored.

A detailed description of step S01 will be described with reference to FIG. 3.

Step S101, the copy list is obtained from the source name node in the source file system by the synchronization control node, a thread pool is established and the source file is allocated to a first thread in the thread pool according to the copy list.

The copy list is a list of a plurality of source files inside the source path. The copy list comprises a plurality of rows of information of the plurality of source files, and a row of information comprises a filename of the source file, a size of the source file and a file path of the source file. In a preferred embodiment, a thread pool is established by the synchronization control node, and the source file is allocated to a first thread in the thread pool, and then the source metadata of the source file and the target metadata of the target file corresponding to the source file are synchronized.

Step S102, the source metadata is obtained by the synchronization control node from the source name node, the plurality of first source block checksums are obtained from the plurality of first source data nodes according to the source metadata;

The source metadata comprises a size of the source file, information about the plurality of first source blocks in the source file, information about the mapping of the plurality of first source blocks to the plurality of first source data nodes. In a preferred embodiment, the plurality of first source block checksums may be obtained from the plurality of first source data nodes according to an IP and a port number of each of the plurality of first source data nodes.

Step S103, the target metadata is obtained by the first thread from the target name node in the target file system, the size of the source file is compared with a size of the target file to obtain a first comparing result, and the target name node is requested to create or delete the plurality of target blocks according to the first comparing result to ensure that the target file is equal to the source file in size, and the target metadata is updated to obtain updated target metadata.

Specifically, the first thread in the synchronization control node may obtain the target metadata from the target name node according to the filename of the source file and the source path, compare the size of the source file with the size of the target file, and request the target name node to create new target blocks to ensure that the target file is equal to the source file in size if the size of the source file is greater than the size of the target file or to delete target blocks in inverse order of their location in the target file to ensure that the target file is equal to the source file in size if the size of the source file is less than the size of the target file.

It should be noted that, if there is no target file corresponding to the source file in the target file system (i.e. the size of the target file is zero), the target name node is requested to create the target file in the size of the source file. A process of creating the target file is a process of creating target blocks. Thus, in a preferred embodiment, a process of comparing the size of the source file with the size of the target file is executed directly without executing a process of determining whether the target file exists.

At step S104, the updated target metadata is obtained by the first thread from the target name node, and the plurality of first target block checksums are obtained from the plurality of first target data nodes according to the updated target metadata. Specifically, after step S103 of creating or deleting the plurality of target blocks, the target metadata is updated, so the updated target metadata is obtained in step S104.

At step S105, the file checksum list is generated by the first thread according to the source metadata, the updated target metadata, the plurality of first source block checksums and the plurality of first target block checksums. The file checksum list comprises a plurality of records; the plurality of records comprise Nos. of the plurality of first source blocks, IDs of the plurality of first source blocks, the plurality of first source block checksums, IDs of the plurality of first source data nodes, the IDs of the plurality of target blocks as a plurality of corresponding target blocks, the plurality of first target block checksums, the IDs of the plurality of first target data nodes as a plurality of corresponding target data nodes and the plurality of mark bits each of which indicates whether each of the plurality of target blocks is a new created target block.

In a preferred embodiment, the source file system and the target file system are HDFSs with a same version. The size of a source block in the source file system is 64 Mb. The size of a target block in the target file system is 64 Mb. If the source file is equal to the target file in size, the plurality of first source blocks correspond respectively to the plurality of target blocks. Thus, a data backup of the plurality of first source blocks may be performed in parallel based on a block as a unit, such that the speed of data transmission is accelerated and time is saved, compared to a related art in which a data backup of files is performed in parallel based on a file as a unit.

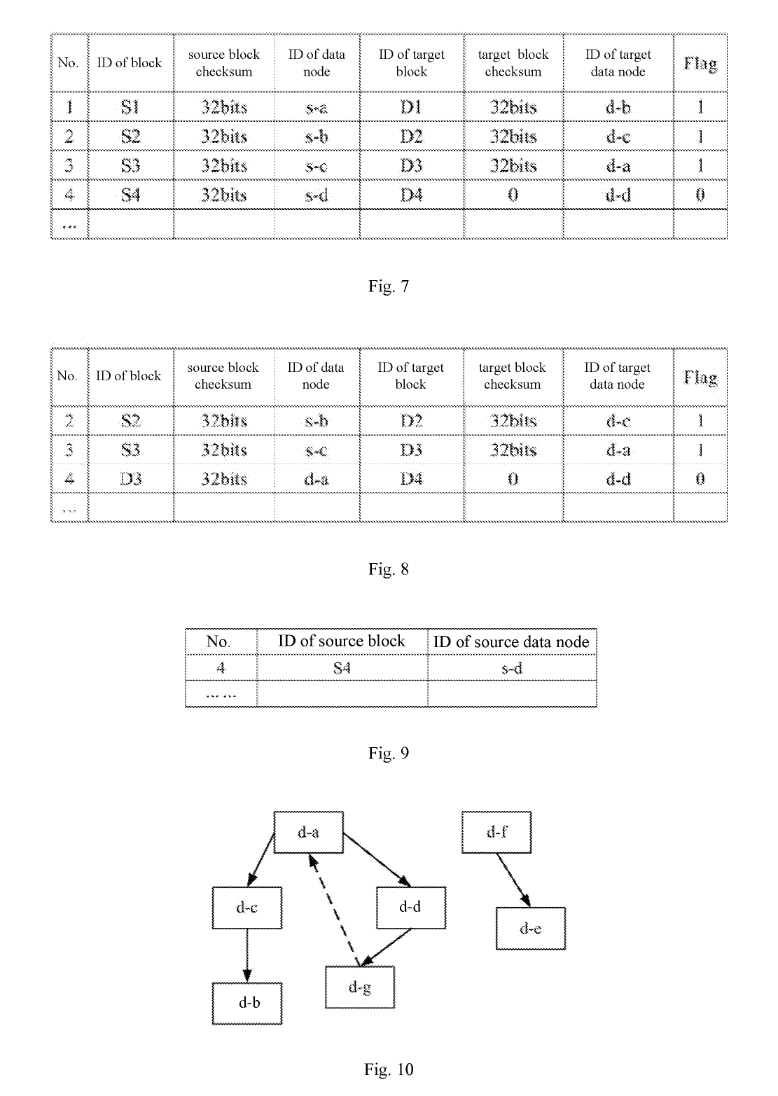

It should be noted that, since the first thread is allocated to the source file by the synchronization control node to perform the data backup of the source file, the first thread generates the file checksum list of the source file. As shown in FIG. 7, a value in a field “No.” represents a no. of one of the plurality of first source blocks, reflecting an access sequence of the plurality of first source blocks. A value in a field “ID of block” represents an ID of one of the plurality of first source block. An ID of a source block is a character string allocated by the source file system to the source block and configured to identify the source block uniquely. An ID of a target block is a character string allocated by the target file system to the target block and configured to identify the target block uniquely. A value in a field “source block checksum” represents a source block checksum of one of the plurality of first source blocks. The source block checksum is a 32-bit hexadecimal numeric string configured to verify the integrality of the one of the plurality of first source blocks. A value in a field “target block checksum” represents a target block checksum of one of the plurality of target blocks. The target block checksum is a 32-bit hexadecimal numeric string configured to verify the integrality of the one of the plurality of target blocks. A value in a field “ID of data node” represents an ID of one of the plurality of first source data nodes. An ID of a source data node is an IP and a port number (such as 10.134.91.70:3800) of the source data node. A value in a field “ID of target data node” represents an ID of one of the plurality of first target data nodes. An ID of a target data node is an IP and a port number of the target data node. A value in a field “Flag” represents a mark bit illustrating whether a target block is a new created target block, and the mark bit is marked as “1” if the target block is not a new created target block or marked as “0” if the target block is a new created target block.

As shown in FIG. 7, the source file comprises four source blocks which are S1 located at source data node s-a, S2 located at source data node s-b, S3 located at source data node s-c and S4 located at source data node s-d. The target file comprises four target blocks which are D1 located at target data node d-b, D2 located at target data node d-c, D3 located at target data node d-a and D4 located at target data node d-d. A value in a field “Flag” corresponding to target block D4 is 0, i.e. target block D4 is created in step 5103. Each of Values in fields “Flag” corresponding to target block D1, D2 and D3 is 1, i.e. target block D1, D2 and D3 exist in the target file before step S103 is executed. A relationship of a source block and a target source block and configurations of the source block and the target source block may be obtained from the file checksum list.

In a word, the synchronization control node establishes the thread pool, allocates the source file to the first thread in the thread pool according to the copy list. The first thread synchronizes the source metadata and the target metadata based on a file as a unit. By step S01, the synchronization of the source metadata and the target metadata is realized, such that there is the target file equal to the source file in size in the target file system, and the file checksum list is generated according to the source metadata, the plurality of first source block checksums, the updated target metadata and the plurality of first target block checksums.

At step S02, differences between the source file and the target file are analyzed by the synchronization control node by determining whether a first source block in the source file is consistent with a first target block in the target file. Specifically, the synchronization control node compares a first source block checksum of the first source block with a first target block checksum of the first target block, determines whether the first source block is consistent with the first target block to obtain a first determining result, and updates information of the first source block and a first source data node corresponding to the first source block in the file checksum list according to the first determining result to obtain a first updated file checksum list, and then sends the first updated file checksum list to a first data node, wherein the first data node is the first source data node or a first target data node corresponding to the first target block and the first data node corresponds to a first block which is the first source block or the first target block.

The first updated file checksum list comprises a plurality of first updated records; the plurality of first updated records comprise Nos. of the plurality of first source blocks, IDs of a plurality of blocks, the plurality of first source block checksums, IDs of a plurality of data nodes, the IDs of the plurality of target blocks as a plurality of corresponding target blocks, the plurality of first target block checksums, the IDs of the plurality of first target data nodes as a plurality of corresponding target data nodes and the plurality of mark bits each of which indicates whether each of the plurality of target blocks is a new created target block. Each of the plurality of blocks is a source block of the plurality of first source blocks or a target block of the plurality of target blocks. Each of the plurality of data nodes is a source data node of the plurality of first source data nodes or a target data node of the plurality of first target data nodes.

In an actual application, the target file system is used as a backup. A data backup process may be performed to ensure that data in the target file system is the same as data in the source file system if a new file is created in the source file system or a file in the source file system is updated. In a related art, when a data backup process is performed by using an instruction “distcp”, the target file is deleted based on a file as a unit, and then data in the source file is sent by a source data node to the target file system to write data in a target file. In this way, the network bandwidth occupancy is high due to transmitting massive data and the network load is high. The differences between the source file and the target file may be a source block created in the source file, a source block updated by a user, a source block deleted from the source file or the order of source blocks updated by the user according to an operation on the source file by the user. That is, most data in the source file is not updated. In addition, in most cases, a network bandwidth between two data nodes in a same cluster is larger than that between two data nodes in different clusters. Thus, in a preferred embodiment, step S02 is executed based on a block as a unit. That is, the first source block is compared with the first target block to determine whether the data in the first source block is sent by the first source data node or by the first target data node.

A detailed description of step S02 will be described with reference to FIG. 4. Each thread in the thread pool executes steps S201-S209 to determine whether the plurality of first source blocks correspond respectively to the plurality of target blocks to obtain a plurality of determining results and to replace the plurality of first source blocks and the plurality of first source data nodes in the file checksum list according to the plurality of determining results in parallel to obtain the first updated file checksum list.

At step S201, a plurality of source hash values of the plurality of first source block checksums and a plurality of target hash values of the plurality of first target block checksums are calculated by using a first hash function.

A block checksum (such as a source block checksum or a target block checksum) of a block is a hexadecimal numeric string calculated by using a digest algorithm, configured to verify the integrality of the block. In a preferred embodiment, the first source block checksum is compared with the first target block checksum to determine whether the first source block is consistent with the first target block. That is, if the first source block checksum is the same as the first target block checksum, the first source block is consistent with the first target block. If the number of the plurality of first source blocks is huge and the number of the plurality of target blocks is huge, it takes long time to compare the plurality of first source block checksums with the plurality of first target block checksums. In a preferred embodiment, in order to improve the efficiency, the plurality of source hash values and the plurality of target hash values are calculated. Firstly, a first source hash value of the first source block checksum is compared with a first target hash value of the first target block checksum. If the first source hash value is different from the first target hash value, the first source block is inconsistent with the first target block. If the first source hash value is the same as the first target hash value, the first source block checksum is compared with the first target block checksum. If the first source block checksum is the same as the first target block checksum, the first source block is consistent with the first target block. The above determining process may refer to steps S202-S205.

In a preferred embodiment, a source hash value is calculated by using the first hash function configured to obtain a remainder by dividing a source block checksum by 128. A target hash value is calculated by using the first hash function configured to obtain a remainder by dividing a target block checksum by 128. FIG. 12 is a schematic diagram illustrating a hash table of the plurality of target blocks. The hash table comprises IDs of the plurality of target blocks, the plurality of first target block checksum and the plurality of target hash values. A value range of each source hash value is 0-127, and a value range of each target hash value is 0-127. Each source hash value corresponds to one or more source block checksums. Each target hash value corresponds to one or more target block checksums. The plurality of source hash values are also stored in the hash table illustrated in FIG. 12.

At step S202, a second source hash value of a second source block checksum of a second source block is compared with the plurality of target hash values.

Specifically, the second source block is compared respectively with the plurality of target blocks to find a target block consistent with the second source block, so as to reduce the amount of data transmitted between data nodes in different clusters. As shown in FIG. 7, assuming that source block S4 is consistent with target block D3, referring to FIG. 1, target block D4 whose No. is the same as that of source block S4 may be obtained by two ways. A first way is that target data node d-a sends a content of target block D3 to target data node d-d. A second way is that source data node s-d sends a content of source block S4 to target data node d-d. Since the network bandwidth between two data nodes in a same cluster is greater than that between two data nodes in different clusters, the first way is suitable for transmitting massive data.

At step S203, it is determined whether there are a plurality of second target block checksums whose hash values are the same as the second source hash value, if yes, step S204 is followed, else step S207 is followed.

At step S204, the second source block checksum is compared with the plurality of second target block checksums.

At step S205, it is determined whether there is a second target block whose target block checksum is the same as the second source block checksum, if yes, step S206 is followed, else step S207 is followed.

Since each source hash value may correspond to one or more source block checksums and each target hash value may correspond to one or more target block checksums, it is needed to determine whether the second source block checksum is the same as a second target block checksum of the second target block to determine whether the second source block is consistent with the second target block if the second source hash value is the same as a second target hash value of the second target block checksum.

At step S206, an ID of the second source block in the file checksum list is replaced with an ID of the second target block, an ID of a second source data node corresponding to the second target block in the file checksum list is replaced with an ID of a second target data node corresponding to the second target block to obtain a second updated file checksum list.

As shown in FIG. 7, assuming that source block 51 is consistent with target block D1, source block S4 is consistent with target block D3, an ID of S1 is replaced with an ID of D1, an ID of source data node s-a corresponding to S1 is replaced with an ID of target data node d-b corresponding to D1, an ID of S4 is replaced with an ID of D3, and an ID of source data node s-d corresponding to S4 is replaced with an ID of target data node d-a corresponding to D3, as shown in the first updated file checksum list in FIG. 8.

In a preferred embodiment, if there is the second target block whose target block checksum is the same as the second source block checksum, then data to be written into the corresponding target block is obtained from the second target block. After step S206 is executed, as shown in the first updated file checksum list in FIG. 8, each value in the field “ID of block” represents an ID of a block to be sent to a corresponding target block, and each value in the field “ID of data node” represents an ID of a data node configured to send the block to be sent. Each value in the field “ID of target block” represents an ID of a corresponding target block and each value in the field “ID of target data node” represents an ID of a corresponding target data node configured to receive a block sent by a data node. It should be noted that, the first updated file checksum list illustrated in FIG. 8 represents data transmission strategies with which the plurality of first source blocks are backed up to a plurality of corresponding target blocks respectively, reflecting information (such as an ID of a data node as a sender, an ID of a corresponding target data node as a receiver, an ID of a block to be sent, an ID of a corresponding target block located at a position where the block to be sent is written and a source block checksum configured to verify the integrality of the block) about the data transmission in the data backup process.

It should be noted that, before the ID of the second source block and the ID of the second source data node are replaced in step S206, the ID of the second source block, the ID of the second source data node and the No. of the second source block are stored in a source file backup table illustrated in FIG. 9. As shown in FIG. 9, the source file backup table comprises Nos. of a plurality of second source blocks, IDs of the plurality of second source blocks and IDs of a plurality of second source data nodes corresponding to the plurality of second source blocks.

At step S207, it is determined whether all of the plurality of first source block checksums are compared with the plurality of first target block checksums, if yes, step S208 is followed, else step S202 is followed.

At step S208, the second updated file checksum list is traversed, a second record in which an ID of a block is the same as an ID of a corresponding target block and an ID of a data node is the same as an ID of a corresponding target data node is deleted to obtain the first updated file checksum list.

Specifically, after step S206 is executed, if there is a second record in which an ID of a block is the same as an ID of a corresponding target block and an ID of a data node is the same as an ID of a corresponding target data node, i.e. the block is the corresponding target block. Thus, a source block corresponding to second row needs not to be backed up, and the second row may be deleted.

As shown in FIG. 7, assuming that source block S1 is consistent with target block D1, the ID of S1 in the file checksum list is replaced with the ID of D1 and the ID of source data node s-a is replaced with the ID of target data node d-b to obtain the second updated file checksum list. At this time, since an ID of a block corresponding to the No. 1 source block is the same as an ID of a corresponding target block corresponding to the No. 1 source block and an ID of a data node corresponding to the No. 1 source block is the same as an ID of a corresponding target data node corresponding to the No. 1 source block in the second updated file checksum list, the block to be sent and the corresponding target block are the same in the record corresponding to No. 1 source block, that is, the No. 1 source block is consistent with the corresponding target block corresponding to the No. 1 source block, the No. 1 source block needs not to be backed up, the record is deleted, as shown in FIG. 8.

At step S209, the plurality of first updated records in the first updated file checksum list are sent respectively to the plurality of data nodes.

Specifically, the plurality of first updated records are sent respectively to the plurality of data nodes according to the IDs of the plurality of data nodes, and the plurality of data nodes back up the plurality of blocks. Referring to FIG. 1 and FIG. 8, the record in which a No. of a source block is 2 is sent to data node s-b, and the record in which a No. of a source block is 4 is sent to data node d-a. Data node s-b is a source data node, and data node d-a is a target data node.

As shown in FIG. 7 and FIG. 8, since target block D3 is consistent with source block S4, D3 may be sent to corresponding target block D4 corresponding to S4. It should be noted that, source block S4 is backed up before source block S3 is backed up. Assuming that, S3 is backed up by writing a content of S3 into D3, and S4 is backed up by writing a content of D3 into D4, at this time, S4 is backed up incorrectly caused by the fact that D3 is no longer consistent with S4.

In view of the above-mentioned facts, if a target block is both a block in a fourth updated records and a corresponding target block in a fifth updated record. The synchronization control node analyzes the interdependency and dependency relationship between corresponding target blocks in the first updated file checksum list, and then sends the plurality of first updated records in the first updated file checksum list in a certain order such that the fourth updated record is sent firstly, and then the fifth updated record is sent after the block in the fourth updated record is backed up.

A detailed description will be described to illustrate step S209 of analyzing the interdependency and dependency relationship between corresponding target blocks in the first updated file checksum list and sending the plurality of first updated records in a certain order with reference to FIGS. 9-11.

1) A plurality of second updated records in which a plurality of data nodes are target data nodes are selected from the first updated file checksum list according to the Nos. of the plurality of second source blocks in the source file backup table. Referring to FIG. 9, a record in which a No. of a source block is 4 is selected from the first updated file checksum list illustrated in FIG. 8.

2) Directed edges are created according to the Nos. of the plurality of second source blocks in the plurality of second updated record to construct a directed acyclic graph. The directed acyclic graph may be constructed by following steps.

a) IDs of a plurality of first data nodes and IDs of a plurality of first corresponding target data nodes in the plurality of second updated records are defined as vertexes and edges from the IDs of the plurality of first data nodes to the IDs of the plurality of first corresponding target data nodes are defined as directed edges. As shown in a directed acyclic graph illustrated in FIG. 10, a directed edge is created according to the record in which a No. of a source block is 4 illustrated in FIG. 8. That is, data node d-a and corresponding target data node d-d are defined as vertexes, the direction of the directed edge between data node d-a and corresponding target data node d-d is from data node d-a to corresponding target data node d-d.

b) The IDs of the plurality of first data nodes are replaced with the IDs of the plurality of first second source data nodes in the source file backup table respectively, IDs of a plurality of first blocks corresponding to the plurality of first data nodes are replaced with the IDs of the plurality of second source blocks in the source file backup table respectively to obtain a plurality of third updated records, and a plurality of rows corresponding to the plurality of second source blocks are deleted from the source file backup table according to the Nos. of the plurality of first blocks if the directed acyclic graph is formed to be a loop according to the directed edges. As shown in FIG. 10, if the directed acyclic graph is formed to be a loop after a directed edge from data node d-g to corresponding target data node d-a is created, the directed edge from data node d-g to corresponding target data node d-a is deleted from the directed acyclic graph.

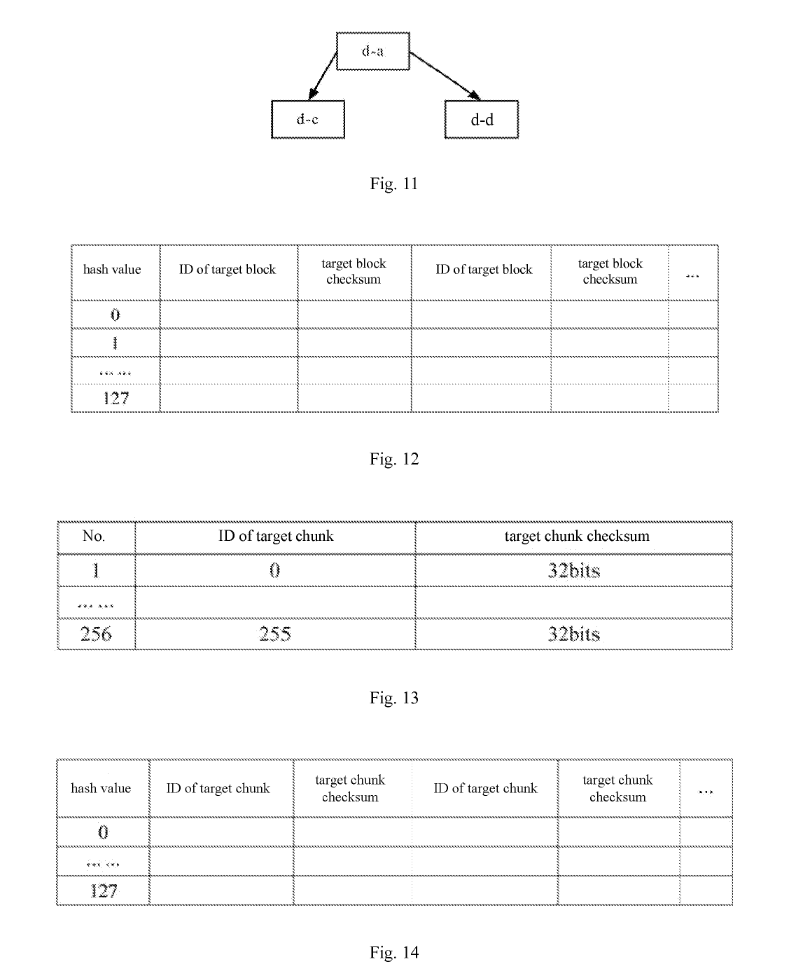

3) A first directed edge corresponding to a vertex with zero out degree is selected from the directed acyclic graph, a third updated record corresponding to the first directed edge is sent and the first directed edge is deleted from the directed acyclic graph. And then, step 3) is repeated until there is no directed edge in the directed acyclic graph. As shown in FIG. 10, since a second directed edge from vertex d-c to vertex d-b corresponds to vertex d-b whose out degree is zero, a third directed edge from vertex d-d to vertex d-g corresponds to vertex d-g whose out degree is zero and a fourth directed edge from vertex d-f to vertex d-e corresponds to vertex d-e whose out degree is zero, records corresponding respectively to the second directed edge, the third directed edge and the fourth directed edge are sent, and the second directed edge, the third directed edge and the fourth directed edge are deleted from the directed acyclic graph, as shown in FIG. 11.

4) A plurality of fourth updated records in which Nos. of a plurality of blocks are not in the source file backup table are sent. That is, the plurality of blocks in the plurality of fourth updated records are not target blocks. The plurality of fourth updated records comprise the plurality of third updated records and a plurality of records in the first updated file checksum list other than the plurality of second updated records.

In a word, by step S02, the plurality of source hash values of the plurality of first source block checksums are compared with the plurality of target hash values and the plurality of first source block checksums of the plurality of first source blocks are compared with the plurality of first target block checksums, it is determined whether the plurality of first source block is consistent respectively with the plurality of target block to obtain a first determining result, and information of the plurality of first source blocks and the plurality of first source data nodes in the file checksum list are updated according to the first determining result to obtain the first file checksum list, and then the plurality of first updated records in the first updated file checksum list are sent to the plurality of data nodes.

It should be noted that, in a preferred embodiment, the block in the detailed description of step S01 (comprising steps S101-S105) and part of the detailed description of step S02 (comprising steps S201-S208) is a source block, the data node in the detailed description of step S01 (comprising steps S101-S105) and part of the detailed description of step S02 (comprising steps S201-S208) is a source data node. The block in steps S03-S04 and part of the detailed description of step S02 (comprising step S209) is a source block or a target block, the data node in steps S03-S04 and part of the detailed description of step S02 (comprising step S209) is a source data node or a target data node.

At step S03, the first updated file checksum list is received by the first data node, a checksum of a first chunk in the first block is compared with a checksum of a first target chunk in a first corresponding target block, it is determined whether the first chunk is consistent with the first target chunk to obtain a second determining result, a first difference list is generated according to the second determining result, and the first difference list and the first updated file checksum list are sent to a first corresponding target data node corresponding to the first corresponding target block.

In a preferred embodiment, the first updated file checksum list reflects data transmission strategies with which the plurality of first source blocks are backed up to the plurality of corresponding target blocks, each record in the first updated file checksum list corresponds to a data transmission strategy with which a source block is backed up to a corresponding target block. In step S02, the plurality of first updated records are sent to the plurality of data nodes by the synchronization control node according to the IDs of the plurality of data nodes in the plurality of first updated records. Each data node receives a record and creates a thread to perform a data backup of a source block. That is, the data backup of a file is based on a block as a unit and performed by the plurality of data nodes.

A block in a HDRS is a basic unit of storage. In a preferred embodiment, in order to determine whether there is a part of the first block consistent with a part of the first corresponding target block, the first block is divided to the plurality of chunks with a same size and the first corresponding target block is divided to the plurality of target chunks with the same size. It is determined whether a first chunk of the plurality of chunks is consistent with a first target chunk of the plurality of target chunks. If there is the first target chunk is consistent with the first chunk, the first corresponding target data node obtains a content of the first target chunk from an inner disk and writes the content of the first target chunk into a second target chunk of the plurality of target chunks corresponding to the first chunk, so as to reduce the amount of data exchange. A chunk refers to a basic unit of a block after the block is divided into two hundred and fifty six and the chunk is a minimum logical unit of storage in the block.

Specifically, in a preferred embodiment, the first chunk is compared with each of the plurality of target chunks to determine whether there is the first target chunk consistent with the first chunk. If there is the first target chunk consistent with the first chunk, the first chunk may be backed up to the second target chunk in two ways. A first way, the content of the first target chunk is obtained and written into the second target chunk. A second way, a content of the first chunk is sent by the first data node to the second target chunk and then is written into the second target chunk. It is does not matter that the first data node is a source data node or a target data node, speed of data transmission in an inner disk in a data node is faster than that of data transmission between different data nodes, so the first way is preferable if the first target chunk is consistent with the first chunk.

A detailed description of step S03 will be described with reference to FIG. 5.

At step S301, a first updated record in the first updated file checksum list is received by the first data node, a first request for a target block checksum list is sent to the first corresponding target data node, the first block is divided into the plurality of chunks and the plurality of chunk checksums are calculated, and a chunk hash value of each of the plurality of chunk checksums is calculated according to a second hash function.

Specifically, the first data node receives the first updated record. Firstly, the first updated record and the first request for a target block checksum list are sent to the first corresponding target data node according to an ID of the first corresponding target block and an ID of the first corresponding data node. Then, the first block is divided into two hundred and fifty six chunks with a same size, and the plurality of chunk checksums are generated by using a MD5 algorithm, Finally, the chunk hash value of each of the plurality of chunk checksums is calculated by using the second hash function configured to obtain a remainder by dividing each of the plurality of chunk checksums by 128. The MD5 algorithm (Message Digest Algorithm 5) is a hash function in a field of computer security and configured to obtaining a 32-bit hexadecimal numeric string according to a variable-length character string. In other embodiments, the chunk checksum of each of the plurality of chunk checksums may be calculated by a sha-1 algorithm, a RIPEMD algorithm or a Haval algorithm.

At step S302, the first updated record and the first request are received by the first corresponding target data node, the first corresponding target block is divided into the plurality of target chunks and the plurality of first target chunk checksums are calculated, and then the target block checksum list is generated and sent to the first data node.

Specifically, the first request is received by the first corresponding target data node, the first corresponding target block is divided into two hundred and fifty six target chunks, and the plurality of first target chunk checksums are calculated according to the MD5 algorithm, and then the target block checksum list illustrated in FIG. 13 is generated. The target block checksum list comprises Nos. of the plurality of target chunks, IDs of the plurality of target chunks and the plurality of first target chunk checksums. The Nos. of the plurality of target chunks reflect an access sequence of the plurality of target chunks, an ID of a target chunk is a integer in a range of 0 to 255 and configured to identify the target chunk uniquely, and a target chunk checksum of a target chunk is a 32-bit hexadecimal numeric string calculated by using the MD5 algorithm and configured to verify the integrity of the target chunk. It should be noted that, in step S301, IDs of the plurality of chunks and the plurality of chunk checksums are stored in a list similar to the target block checksum list illustrated in FIG. 13 by the first data node.

At step S303, a plurality of target chunk hash values of the plurality of first target chunk checksums are calculated by the first data node by using the second hash function and a second difference list is generated.

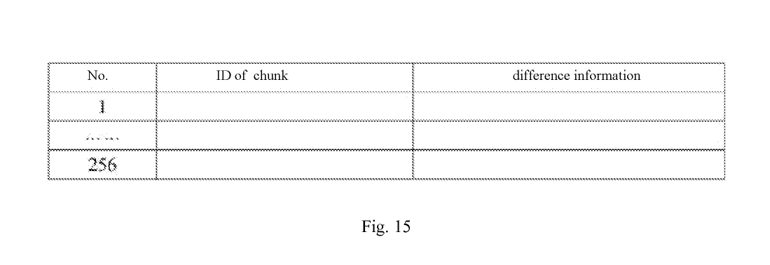

Specifically, the target block checksum list is received by the first data node, a target chunk hash value of each of the plurality of first target chunk checksums is calculated by using the second hash function configured to obtain a remainder by dividing each of the plurality of first target chunk checksums by 128, and then the target hash value of each of the plurality of first target chunk checksums is stored in a hash table illustrated in FIG. 14 and the source block difference table illustrated in FIG. 15 is generated. As shown in FIG. 14, the hash table comprises the plurality of target chunk hash values, IDs of the plurality of target chunks and the plurality of first target chunk checksums. Each target chunk hash value is an integer in the range of 0 to 127, and may correspond to several target chunk checksums. As shown in FIG. 15, the second file target difference table comprises Nos. of the plurality of chunks, IDs of the plurality of chunks and a plurality of pieces of different information.

At step S304, it is determined by the first data node whether the first corresponding target block is a new created target block according to the first updated record, if the first corresponding target block is a new created target block, step S312 is followed, else step S305 is followed.

Specifically, a value in a field “Flag” corresponding to the first corresponding target block in the first updated file checksum list is a mark bit indicating whether the first corresponding target block is a new created target block. If the value in a field “Flag” corresponding to the first corresponding target block is 1, the first corresponding target block is not a new created target block. If the value in a field “Flag” corresponding to the first corresponding target block is 0, the first corresponding target block is a new created target block created in step S01. If the first corresponding target block is a new created target block, a content of the first corresponding target block is noting, contents of the plurality of chunks are written into the plurality of pieces of difference information without comparing the plurality of chunks with the plurality of target chunks, referring to step S312.

It should be noted that, the method of determining whether a chunk is consistent with a target chunk is similar to the method of determining whether a source file target is consistent with a target block. Specifically, a chunk hash value of a chunk checksum of a chunk is compared with a target chunk hash value of a target chunk checksum of a target chunk, if the chunk hash value is different from the target hash value, the chunk is inconsistent with the target chunk, else if the chunk checksum is the same as the target chunk checksum, the chunk is consistent with the target chunk, else the chunk is inconsistent with the target chunk. A process of determining whether there is a second target chunk is consistent with a second chunk may refer steps S305-S308.

At step S305, a second chunk hash value of a second chunk checksum of the second chunk is compared respectively with the plurality of target chunk hash values.

At step S306, it is determined whether there are a plurality of second target chunk checksums whose target chunk hash values are the same as the second chunk hash value, if there are, step S307 is followed, else step S310 is followed.

At step S307, the plurality of second target chunk checksums are compared with the second chunk checksum.

At step S308, it is determined whether there is the second target chunk whose target chunk checksum is the same as the second chunk checksum, if there is, step S309 is followed, else step S310 is followed.

At step S309, an ID of the second chunk in the second difference list is replaced with an ID of the second target chunk to obtain the first difference list.

Specifically, if there is the second target chunk whose target chunk checksum is the same as the second chunk checksum and whose target hash value is the same as the second chunk hash value, the second target chunk is consistent with the second chunk. The ID of the second chunk in the second difference list is replaced with the ID of the second target chunk.

At step S310, the content of the second chunk is written into a second piece of difference information corresponding to the second chunk, and the ID of the second chunk is replaced with NULL to obtain the first difference list.

If there is no target chunk consistent with the second chunk, the content of the second chunk is written into the second piece of difference information corresponding to the second chunk and the ID of the second chunk is replaced with NULL, which indicates the content of the second chunk may be obtained from the second piece of difference information instead of from a target chunk.

At step S311, it is determined whether all of the plurality of chunk checksums are compared with the plurality of first target chunk checksums, if yes, step S313 is followed, else step S305 is followed.

At step S312, if the first corresponding target block is a new created target block, contents of the plurality of chunks are written into the pieces of difference information, and IDs of the plurality of chunks are replaced with NULL to obtain the first difference list.

At step S313, the first difference list is sent by the first data node to the first corresponding target data node.

Specifically, the first data node sends the first difference list to the first corresponding target data node according to the ID of the first corresponding data node in the first updated record.

In a word, by step S03, the plurality of chunk checksums, the plurality of chunk hash values, the plurality of first target chunk checksums, and the plurality of target chunk hash values are calculated, it is determined whether the plurality of chunks are consistent respectively with the plurality of target chunks to obtain a plurality of second determining results by comparing the plurality of chunk hash values with the plurality of target hash values and comparing the plurality of chunk checksums with the plurality of first target chunk checksums, and the first difference list is generated according to the plurality of second determining results and the first difference list is sent to the first corresponding target data node.

At step S04, the temporary block is created by the first corresponding target data node, data is written into the temporary block according to the first difference list and the first corresponding target block is replaced with the temporary block.

A detailed description of step S04 will be described with reference to the flow chart of step S04 illustrated in FIG. 6.

At step S401, the first corresponding target data node receives the first difference list sent by the first data node and creates the temporary block in a size of the first corresponding target block.

At step S402, the first difference list is traversed, it is determined whether an ID of a third chunk in the first difference list is NULL, if yes, step S403 is followed, else step S404 is followed.

At step S403, a third piece of difference information corresponding to the third chunk is obtained and written into the temporary block.

At step S404, a content of the third chunk is obtained and written into the temporary block.

At step S405, it is determined whether all of chunks in the first difference list are determined, if yes, step S406 is followed, else step S402 is followed.

At step S406, the first corresponding target block is replaced with the temporary block.

In a word, by step S04, the temporary block is created, data is written into the temporary block according to the first difference list, and the first corresponding target block is replaced with the temporary block.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A data backup method of a distributed file system, applied in a source file system and a target file system, comprising:
a metadata synchronization step of obtaining by a synchronization control node a copy list according to a source path in a data backup request input from a client, synchronizing target metadata of a target file in the target file system according to source metadata of a source file in the copy list, and generating a file checksum list corresponding to the source file;
a file difference analysis step of comparing by the synchronization control node a checksum of a first source block in the source file with a checksum of a first target block in the target file, determining whether the first source block is consistent with the first target block to obtain a first determining result, and updating information of the first source block and a first source data node corresponding to the first source block in the file checksum list according to the first determining result to obtain a first updated file checksum list, and sending the first updated file checksum list to a first data node, wherein the first data node is the first source data node or a first target data node corresponding to the first target block, and the first data node corresponds to a first block which is the first source block or the first target block;
a block difference analysis step of receiving by the first data node the first updated file checksum list, comparing a checksum of a first chunk in the first block with a checksum of a first target chunk in a first corresponding target block, determining whether the first chunk is consistent with the first target chunk to obtain a second determining result, generating a first difference list according to the second determining result, and sending the first difference list and the first updated file checksum list to a first corresponding target data node corresponding to the first corresponding target block; and
a data backup step of creating a temporary block by the first corresponding target data node, and writing data in the temporary block according to the first difference list and replacing the first corresponding target block with the temporary block.

2. The method according to claim 1, wherein the copy list comprises a plurality of rows of information of a plurality of source files inside the source path, and a row of information comprises a filename of the source file, a size of the source file and a file path of the source file; and the source file comprises a plurality of first source blocks having a plurality of first source block checksums respectively and corresponding to a plurality of first source data nodes respectively; and the target file comprises a plurality of target blocks having a plurality of first target block checksums respectively and corresponding to a plurality of first target data nodes respectively; and the file checksum list comprises a plurality of records; a record comprises an No. of a source block of the plurality of first source blocks, an ID of the source block, a checksum of the source block, an ID of a source data node corresponding to the source block, an ID of a corresponding target block corresponding to the source block, a checksum of the corresponding target block, an ID of a corresponding target data node corresponding to the corresponding target block and a mark bit indicating whether the corresponding target block is a new created target block; and the first updated file checksum list comprises a plurality of first updated records; an updated record corresponding to the record comprises the No. of the source block, an ID of a block, a checksum of the block, an ID of a data node corresponding to the block, the ID of a corresponding target block, the checksum of the corresponding target block, the ID of the corresponding target data node and the mark bit; wherein the block is one of the plurality of first source blocks or one of the plurality of target blocks.

3. The method according to claim 2, wherein the metadata synchronization step comprises:
A1: obtaining the copy list, establishing a thread pool and allocating the source file to a first thread in the thread pool according to the copy list;
B1: obtaining by the first thread the source metadata, obtaining the plurality of first source block checksums from the plurality of first source data nodes according to the source metadata;
C1: obtaining by the first thread the target metadata from a target name node in the target file system, comparing a size of the source file with a size of the target file to obtain a first comparing result, requesting the target name node to create or delete the plurality of target blocks according to the first comparing result to ensure that the target file is equal to the source file in size, and updating the target metadata to obtain updated target metadata;
D1: obtaining by the first thread the updated target metadata, and obtaining the plurality of first target block checksums from the plurality of first target data nodes according to the updated target metadata;
E1: generating the file checksum list by the first thread according to the source metadata, the updated target metadata, the plurality of first source block checksums and the plurality of first target block checksums.

4. The method according to claim 2, wherein the file difference analysis step comprises:
A2: comparing a second source block checksum of a second source block of the plurality of first source blocks with the plurality of first target block checksums and determining whether there is a second target block consistent with the second source block;
B2: if there is the second target block consistent with the second source block, replacing an ID of the second source block in the file checksum list with an ID of the second target block, and replacing an ID of a second source data node in the file checksum list with an ID of a second target data node to obtain a second updated file checksum list, else going step A2, wherein the second source data node is corresponding to the second source block and the second target data node is corresponding to the second target block;
C2: determining whether all of the plurality of first source block checksums are compared with the plurality of first target block checksums, if yes, going step D2, else going step A2;
D2: traversing the second updated file checksum list, deleting a second updated record in which an ID of a block is the same as an ID of a corresponding target block and an ID of a data node is the same as an ID of a corresponding target data node to obtain the first updated file checksum list;
E2: sending the plurality of first updated records respectively to the plurality of data nodes.

5. The method according to claim 2, wherein the block difference analysis step comprises:
A3: receiving by the first data node a first updated record, and sending the first updated record and a first request for a target block checksum list to the first corresponding target data node;
B3: dividing by the first data node the first block into a plurality of chunks with a same size, and calculating a plurality of chunk checksums of the plurality of chunks by using a digest algorithm;
C3: receiving by the first corresponding target data node the first updated record and the first request, and dividing the first corresponding target block into a plurality of target chunks with a same size and calculating a plurality of first target chunk checksums of the plurality of target chunks to generate the target block checksum list, and sending the target block checksum list to the first data node, wherein the target block checksum list comprises: Nos. of the plurality of target chunks, IDs of the plurality of target chunks and the plurality of first target chunk checksums;
D3: receiving by the first data node the target block checksum list and creating a second difference list, wherein the second difference list comprises: Nos. of the plurality of chunks, IDs of the plurality of chunks and a plurality of pieces of difference information;
E3: comparing a second chunk checksum of a second chunk of the plurality of chunks with the plurality of first target chunk checksums and determining whether there is a second target chunk consistent with the second chunk;
F3: if there is the second target chunk consistent with the second chunk, replacing an ID of the second chunk in the second difference list with an ID of the second target chunk to obtain the first difference list;
G3: if there is no target chunk consistent with the second chunk, replacing the ID of the second chunk with NULL and writing a content of the second chunk into a second piece of difference information corresponding to the second chunk to obtain the first difference list;
H3: determining whether all of the plurality of chunk checksums are compared with the plurality of first target chunk checksums, if yes, going step I3, else going step E3;
I3: sending the first difference list to the first corresponding target data node.

6. The method according to claim 2, the data backup step comprises:
A4: receiving by the first corresponding target data node the first difference list, and creating the temporary block whose size is the same as that of the first corresponding target block;
B4: determining whether an ID of a third chunk in the first difference list is NULL;
C4: if the ID of the third chunk is not NULL, obtaining a content of the third chunk, and writing the content of the third chunk into the temporary block, else obtaining a third piece of difference information corresponding to the third chunk from the first difference list and writing the third piece of difference information into the temporary block;
D4: determining whether all of chunks in the first difference list are determined, if yes, going step E4, else going step B4;
E4: replacing the first corresponding target block with the temporary block.

7. The method according to claim 4, wherein step A2 comprises:
a1: calculating a second source hash value of the second source block checksum and a plurality of target hash values of the plurality of first target block checksums by using a first hash function;
a2: comparing the second source hash value and the plurality of target hash values;
a3: if there is no target hash value the same as the second source hash value, there is no target block consistent with the second source block;
a4: if there are a plurality of second target block checksums whose hash values are the same as the second source hash value, comparing the second source block checksum with the plurality of second target block checksums;
a5: if there is the second target block whose checksum is the same as the second source block checksum, the second target block is consistent with the second source block.

8. The method according to claim 5, wherein the block difference analysis step further comprises:
determining whether the first corresponding target block is a new created target block according to the mark bit;
if yes, writing contents of the plurality of chunks into the plurality of pieces of difference information, replacing the IDs of the plurality of chunks in the second difference list with NULL to obtain the first difference list, and going step I3;
if no, going step E3.

9. The method according to claim 5, wherein step E3 comprises:
e1: calculating a second chunk hash value of the second chunk checksum and a plurality of target chunk hash values of the plurality of first target chunk checksums by using a second hash function;
e2: comparing the second chunk hash value and the plurality of target chunk hash values;
e3: if there is no target chunk hash value the same as the second chunk hash value, there is no target chunk consistent with the second chunk;
e4: if there are a plurality of second target chunk checksums whose hash values are the same as the second chunk hash value, comparing the second chunk checksum with the plurality of second target chunk checksums;
e5: if there is the second target chunk whose checksum is the same as the second chunk checksum, the second target chunk is consistent with the second chunk.

10. The method according to claim 4, wherein if there is the second target block consistent with the second source block, the file difference analysis step further comprises:
storing the ID of the second source block, the ID of the second source data node and a No. of the second source block in a source backup table, wherein the source backup table comprises: Nos. of a plurality of second source blocks, IDs of the plurality of second source blocks and IDs of a plurality of second source data nodes corresponding to the plurality of second source blocks.

11. The method according to claim 10, wherein step E2 comprises:
e11: selecting a plurality of second updated records in which a plurality of data nodes are target data nodes from the first updated file checksum list according to the Nos. of the plurality of second source blocks;
e12: establishing a plurality of directed edges to construct a directed acyclic graph according to the plurality of second updated records;
e13: selecting a first directed edge corresponding to a vertex with zero out degree from the directed acyclic graph, sending a third updated record corresponding to the first directed edge and deleting the first directed edge from the directed acyclic graph, and repeating step el3 until there is no directed edge in the directed acyclic graph;
e14: sending a plurality of fourth updated records in which Nos. of a plurality of blocks are not in the source backup table.

12. The method according to claim 11, wherein establishing a plurality of directed edges to construct a directed acyclic graph comprises:
defining IDs of a plurality of first data nodes and IDs of a plurality of first corresponding target data nodes in the plurality of second updated records as vertexes, defining edges from the IDs of the plurality of first data nodes to the IDs of the plurality of first corresponding target data nodes as directed edges;
replacing the IDs of the plurality of first data nodes respectively with the IDs of the plurality of second source data nodes and replacing IDs of a plurality of first blocks corresponding to the plurality of first data nodes respectively with the IDs of the plurality of second source blocks, and deleting from the source backup table a plurality of rows corresponding to the plurality of second source blocks, if the directed acyclic graph is formed to be a loop according to the plurality of directed edges.
